(19) United States
(12) Patent Application Publication
(10) Pub. No.: US 2005/0024798 A1
(43) Pub. Date: Feb. 3, 2005

(54) Enhanced method and apparatus for protecting against bolted short, open neutral, and reverse polarity conditions in an electronic circuit

(76) Inventors: Aaron L. Reynoso, San Jose, CA (US); Lloyd T. Ebisu, Cupertino, CA (US)

Correspondence Address: CENTRAL COAST PATENT AGENCY, PO BOX 187, AROMAS, CA, 95004, US

(21) Appl. No.: 10/631,435

(22) Filed: Jul. 30, 2003

(51) Int. Cl. H02H 3/00

(52) U.S. Cl. 361/42

(57) ABSTRACT

A protection circuit for generating current to activate a Trip Solenoid of a circuit breaker in response to a detected fault includes, an electrical connection from the circuit to a terminal of Solenoid; an electrical connection from the circuit to a Neutral wire; an electrical connection from the circuit to an Earth Ground wire; at least one voltage detection mechanism for detecting a fault condition; and at least one Transistor electrically accessible from at least one voltage detection mechanism for generating current to activate the Trip Solenoid. In operation of the circuit one of at least one voltage detection mechanism detects a voltage anomaly between Neutral and Earth Ground and activates one of at least one Transistor to generate a source-to-ground current, the generated current traveling through the Trip Solenoid and the protection circuit to Earth Ground, the generated current sufficient to activate the Trip Solenoid thereby opening the circuit breaker.

### FIELD OF THE INVENTION

The present invention is in the field of electrical voltage distribution and pertains more particularly to a discrete protection circuitry and method of operation thereof for protecting against Bolted Short, Open Neutral, and Reverse Polarity conditions that can occur in a voltage distribution path from a distribution panel to Load.

### BACKGROUND OF THE INVENTION

In the field of Alternating Current (AC) voltage distribution, for example, voltage distribution through a distribution panel to one or more load appliances, there are typically a plurality of secondary or sub-main AC circuit breakers marking distribution points, or provided somewhere in the paths to local outlets and switches or directly connected Load appliances. These circuits can be part of the distribution channel itself or can be distributed out along the voltage distribution wires leading to Load and in some cases may be integrated to Load.

In the case of multiple distribution points, they are typically governed by a main circuit breaker of a thermal or magnetic type that can be tripped to cut off power through all of the Load paths. The sub-main breakers typically can range from 10 to 100 AMP with 30 or 60 Amp breakers being common. Sub-main or secondary breakers govern particular distribution paths or channels, which may contain one or multiple Load points. In some cases appliances have their own integrated circuit breakers as described above. As is known in the art, there are certain conditions that, if existing in a voltage distribution path to Load can be extremely dangerous to users.

One of the above-described conditions is known in the art as a Bolted Short. A Bolted Short is characterized by the conductors of different potential being “bolted” together as opposed to lightly touching and thereby causing arcing. For all practical purposes, in Bolted Short Circuit, the load or the protection circuit is no longer in the normal circuit path and the voltage across them goes to zero volts. This can be devastating to the electrical wiring because energy of the source is only limited by the resistance (impedance) of the circuit components. Typically, there are three wires in an AC electrical voltage distribution path. These are a Phase (or Hot) wire, a Neutral wire, and a Ground wire. A Bolted Short condition exists when the Phase and Neutral wires of an AC circuit path suffer a fixed short. Under a Bolted Short condition, normal current flow through the circuit of a few tens of amps suddenly increases to a current of several hundreds of amps causing the conductor wires to overheat potentially causing electrical fires in certain environments.

When a Bolted Short occurs and the AC circuit begins to get hot due to current increases above the rated level, the main circuit breaker of the panel will eventually trip in order to halt current flow. However, the lead-time between occurrence of the short and cut-off of power from the main breaker can vary according to the distance of the short from the main breaker.

Possible causes of a Bolted Short condition in an AC circuit include short circuit failures in the associated load appliance, compromised wires leading into the load, and so on. When a Bolted Short condition exists, the voltage between Phase and Neutral at the load drops to almost 0V AC, however, the Phase In voltage remains constant. All Trip Solenoid-type or electronic circuit breakers require a non-zero voltage between Phase and Neutral to provide sufficient Solenoid activation current. Hence, Solenoid type circuit breakers cannot successfully operate during a Bolted Short condition.

Another electrical fault is the Open Neutral condition. An Open Neutral condition occurs when the Neutral wire from the power line becomes disengaged from the load appliance in the circuit. The Phase line remains connected to the load causing the entire load appliance to “float” at the Phase-line voltage which could be 120 volts or higher. At this time, coming into contact with any part of the load appliance can result in serious injury to a user.

A third fault is the Reverse Polarity condition. The Reverse Polarity condition occurs when a Phase line and Neutral line are inadvertently reversed in connection. Similar to the Open Neutral condition, the Reverse Polarity condition can cause serious injury to a user coming into contact with the load appliance. Operational problems also result. Single-pole circuit breakers will open the Phase line, however in a Reverse Polarity condition the “Phase Line” is connected to the “Neutral Line”. The Phase line remains connected to the load appliance causing the entire load to “float” as described further above.

Attempts have been made to provide some protection against one or more of the conditions described above. The inventors are aware of a protection circuit referenced herein as U.S. Pat. No. 4,598,331, issued on Jul. 1, 1986 entitled “Ground Fault Current Interrupter Circuit with Open Neutral and Ground Lead Protection”. This device is a modified GFCI that protects against Open Neutral and Open Ground conditions by creating actuation of an interrupter circuit, as well as a Ground fault.

Referring now to U.S. Pat. No. 4,598,331, more particularly to FIG. 2 of that specification, a GFCI is modified with a supplemental secondary winding (71) of wire on its differential transformer 29. An Open Neutral lead or an Open Ground Lead produces a current flow through the supplemental secondary winding (71) that induces a trip signal in the secondary winding 71 that initiates opening of the power line 11.

In a second implementation winding (71) induces a trip signal in the transformer (29) only for an Open Ground lead, while tripping for an Open Neutral is achieved by directly gating a Silicon Controlled Rectifier (SCR) switch. The circuit arrangements also protect against other conditions, such as a potential in excess of a predetermined voltage between the neutral and ground leads or a reversal of the input connections.

Referring now to FIG. 2 of the same specification, Zener Diode 117 is added (as shown) to help reduce or eliminate this undesirable ground current through diode 53. However, the addition of Zener diode (117) causes a reduction in activation current through the Trip Solenoid during a fault condition by adding another voltage drop between the Trip Solenoid and the voltage source resulting in a possible lengthening of the trip response-time of the circuit.

Another drawback with the GFCI module described above is that the design depends on the current flow from Neutral to Ground through sense winding 71 to be detected by the GFCI module, which then generates the trip activation. This design is capable of activating the Trip Solenoid when the Phase and Neutral connections are reversed. However the added diodes providing functionality depend upon being integral components of the GFCI device itself.

The inventors are also aware of a circuit referenced herein by U.S. Pat. No. 4,947,278 entitled “Remote Sensing Power Disconnect Circuit” issued on Aug. 7, 1990. This device provides a Ground fault across an electrical outlet when an unsafe condition such as an Open or lost Neutral or shorting of the AC power switch is detected. The remote control power disconnect circuit is placed at each electrical outlet within a dwelling and applies AC power to the outlet only when an appliance (Load) is plugged into the outlet and no fault condition is detected. Upon detecting a fault condition, the circuit applies a ground fault across the outlet to shut-off the supply of AC power to the outlet.

Referring now by reference to FIG. 3 of U.S. Pat. No. 4,947,278, a drawback with the above-described circuit (12) is that it only offers protection against an Open-Neutral Condition or a shorted AC switch and not for a Bolted Short. The circuit also depends on an upstream GFCI device for function. Circuit (12) alone does not generate current of the necessary amperage for driving the Trip Solenoid of a typical mechanical circuit breaker. Additionally, circuit (12) consumes a constant current in order to continually bias the Open-Neutral activator VR1, Resistor R5, and SCR1 off during normal operation.

The inventors are aware of yet another protection circuit referenced herein by U.S. Pat. No. 6,560,079 entitled “Ground Loss Detection For Electrical Appliances” issued on May 6, 2003. This circuit is integrated with a host appliance functioning as a Load appliance. The circuit utilizes semiconductor devices known as Triac devices in order to disconnect AC power from the appliance load. It is known that semiconductor devices have a maximum current rating that can safely be handled by a host appliance.

In the event of a Bolted Short condition wherein the current exposed to the Triac devices is much higher than their maximum load rating, the Triac devices can be permanently damaged. The Triacs can turn off during their respective 0 voltage crossings of the AC current cycle through the circuit. However, when a Bolted Short fault occurs, the amount of generated current reaches its peak value at a point halfway from the 0 voltage crossing point of the AC current. This factor can also cause damage to the Triac devices. Moreover, the circuit is involved in “Ground detection“ whereby current flows through the circuit to Ground in order to maintain a “latched on” state of one of the Triacs.

The inventors are also aware of a protection circuit referenced herein by a U.S. Pat. No. 4,931,893, entitled “Loss of Neutral or Ground Protection Circuit” issued on Jun. 5, 1990. This circuit uses a Trip Solenoid to open a mechanical circuit breaker upon the detection of an Open Neutral or Open Ground connection. The circuit also uses Zener diodes to set the trip activation threshold voltage. The circuit also works in conjunction with standard GFCI devices.

Referring now by reference to FIG. 1a of U.S. Pat. No. 4,931,893, although this circuit is capable of protection against an Open Neutral or an Open Ground condition, it relies on a “full-bridge rectifier” to generate a biasing voltage across a capacitor (C2). Therefore, the circuit consumes current during normal operation to maintain the bias state. Lastly, the circuit uses SCR (Q1), referenced herein by FIG. 1 and SCR (Q2) in FIG. 2 of the same specification in order to activate the Trip Solenoid of the mechanical circuit breaker. The problem with the design is that because of the manner in which the SCR is connected to the circuit only one half of the full AC cycle is available (positive half) to activate the Trip Solenoid. It is important to note herein as well that the disadvantages of using SCR's are well known in the art. Particularly, a high dv/dt value is required in order to resist inadvertent power on when voltage transients occur on the line voltage. Once powered on, an SCR will remain on until the current through the SCR falls below a specific level.

The above-described circuit has its own activation path (Q2) for activating the Trip Solenoid when operating in conjunction with a GFCI device to detect a Ground Fault condition. In this case again only half of the available current is used to activate the solenoid.

Finally, the inventors are aware of yet another protection circuit referenced herein by a U.S. Pat. No. 4,994,933 entitled “Ground Fault Circuit Interrupter Having Loss of Neutral or Loss of Ground Protection” issued on Feb. 19, 1991. The circuit referenced herein provides protection in the event of loss of Neutral or Ground, excess potential between Neutral and Ground and reversed input connections. Separate, independent tripping circuits are used for these latter faults and for Ground faults eliminating problems due to interfering signals and reducing reliance on any one component or group of components. An opto-emitter and opto-detector arrangement is used for detecting and causing tripping of a circuit breaker in the event of faults other than Ground faults. This circuit is a full-function GFCI.

Referring now by reference to FIG. 1 of U.S. Pat. No. 4,994,933, circuit (1) detects Open Neutral and Reversed Phase/Neutral conditions by way of addition of an opto-emitter (25), a detector (30) and a resistor (21). The trip activation of circuit (1) is set by adjusting the value of resistors 21 and the resistor connected to optoemitter 25 (R27), which does not have a specific switching threshold. Moreover, implementation of resistor 21 and (27) in the illustrated array along with that of diode 26 and opto-emitter 25 causes the current flow to always be from Phase to Ground during normal operation. It is desirable not to have current flow to Ground under normal conditions. Section 250-6 (c) of the National Electrical Code (NEC) allows for only temporary currents.

There is no independent path for solenoid trip activation under a Bolted Short condition. This circuit activates through the normal GFCI path of SCR (7) and Trip Solenoid (6). Circuit (1) derives power from Line (2) and Neutral (3) wires. Therefore it cannot operate during a Bolted-Short condition.

What is clearly needed in the art is a method and apparatus for tripping a Solenoid to shut off Phase whenever any one of the three above-described problematic conditions occurs. The apparatus can be implemented using standard discrete circuitry or in ASIC form and can be implemented along side standard circuit breakers such as a Ground Fault Circuit Interrupter (GFCI), an Arc Fault Circuit Interrupter (AFCI) Over Current Detection Trip (OCDT) module or any electronic type circuit breaker without interfering with the normal operations of these devices, and without drawing current when idle under normal operating conditions.

### SUMMARY OF THE INVENTION

In a preferred embodiment of the present invention a protection circuit for generating sufficient current to activate a trip solenoid of a circuit breaker installed in an AC voltage distribution load path in response to a detected fault condition is provided, comprising an electrical connection from the circuit to a terminal of the trip solenoid, an electrical connection from the circuit to a neutral wire of the load path, an electrical connection from the circuit to a ground wire of the load path, at least one voltage detection mechanism for detecting a fault condition, and at least one transistor electrically accessible from at least one voltage detection mechanism for generating sufficient current to activate the trip solenoid. The circuit is characterized in that one of at least one voltage detection mechanism detects a voltage anomaly between the neutral wire and the ground wire resultant of a fault occurrence and activates one of at least one transistor to generate a source-to-ground current independently from the circuit breaker, the generated current traveling through the trip solenoid and the protection circuit to ground, the generated current sufficient to activate the trip solenoid thereby opening the circuit breaker.

In a preferred embodiment the circuit breaker is one of a ground fault circuit interrupter, an arc fault circuit interrupter, or an over current trip detector. Also in a preferred embodiment fault condition is one of a bolted short or an open neutral condition. In some embodiments the voltage anomaly detected is a voltage drop across inherent neutral wire impedance resulting from a bolted short condition. In some other embodiments the voltage anomaly detected is a voltage rise across a load neutral connector resulting from an open neutral condition. In yet other embodiments there may two voltage detection mechanisms for detecting the voltage anomaly, one operative during the negative alternating current half cycle, and one operative during the positive alternating current half cycle.

In some other embodiments of the invention the voltage detection mechanisms each include a Zener diode and one or more resistors. In still other embodiments at least one transistor is a metal-oxide semiconductor field-effect transistor (MOSFET). In still other embodiments there are two MOSFETs, one operative during the negative alternating current half cycle and one operative during the positive alternating current half cycle. In yet other embodiments there is an off state during no-fault operation and an on state upon detection of a fault, the circuit returning again to the off state after tripping the circuit breaker and the fault condition is removed. In some cases the detection-to-activation response time is less than one AC half cycle. In yet others the level of trip solenoid activation current is adjustable using a voltage adjustment mechanism.

In another aspect of the invention, in an AC voltage distribution environment, a method for detecting a fault condition and for generating a current to activate a trip solenoid of a circuit breaker protecting a load is provided, comprising steps of: (a) providing a protection circuit between the power distribution source and Ground, the protection circuit having a connection to one terminal of the trip solenoid, a connection to neutral, a connection to ground, at least one voltage detection mechanism, and at least one voltage transistor; (b) detecting a voltage anomaly using one of at least one voltage detection mechanism, the voltage anomaly resultant of an existing fault; (c) exceeding a voltage-blocking threshold of the voltage detection mechanism of step (b); (d) activating one of at least one semiconductor switch (such as a transistor) as a direct result of step (c); (e) drawing current through the trip solenoid from the transistor of step (d) and (f) breaking the circuit.

In some in step (b) the voltage detection mechanism includes a Zener diode, at least one resistor, and the semiconductor switch is a MOSFET. Also in some embodiments the electronic circuit breaker is one of a GFCI, an AFCI, or an OCTD circuit. In still other embodiments in step (b) the voltage anomaly is one of a voltage drop across a neutral wire impedance or a rise in voltage at neutral load connector. In yet other embodiments in step (b) the existing fault is one of a bolted short or an open neutral condition. In yet other embodiments in step (c) the voltage threshold is that of a Zener diode, and in step (d) the semiconductor switch is a MOSFET. In some other embodiments of the method, in step (e) the current path includes the protection circuit and earth ground, bypassing the circuit breaker module.

In another aspect of the invention a protection circuit for causing a GFCI to activate an associated trip solenoid upon detection of a reverse neutral and phase connection in an AC voltage distribution-to-load path is provided, comprising an electrical connection from the circuit to a neutral wire of the AC current load path, an electrical connection from the circuit to an earth ground wire of the AC current load path, and at least one voltage detection mechanism for detecting the reverse neutral and phase connection. The circuit is characterized in that upon supplying power to the AC voltage distribution-to load path, current flows through the at least one voltage detection mechanism to ground thereby causing a current anomaly between phase and neutral, the anomaly sensed by a sensing coil of the GFCI, which then generates the current to activate the trip solenoid shutting off phase power to load.

In yet another aspect a protection circuit for generating sufficient current for activating a trip solenoid of a circuit breaker installed in a DC voltage distribution load path in response to a detected fault is provided, comprising an electrical connection to VDC, an electrical connection to DC sense wire, a voltage detection mechanism for detecting a voltage anomaly, and a transistor for generating a current through the solenoid and through the protection circuit to the DC sensing wire. This circuit is characterized in that the voltage detection mechanism detects a voltage anomaly between the VDC− wire and the DC sense wire resultant of a fault occurrence and activates the transistor to generate a source-to-ground current independently from the circuit breaker, the generated current traveling through the trip solenoid and the protection circuit to DC Sense, the generated current sufficient to activate the trip solenoid thereby opening the circuit breaker. In some embodiments of the circuit the fault is one of a bolted short or an open VDC-condition.

In yet another embodiment of the invention, in a DC voltage distribution environment, a method for detecting a fault condition and for generating a current to activate a trip solenoid of a circuit breaker protecting a load is provided, comprising steps of (a) providing a protection circuit between the power distribution source and DC sense, the protection circuit having a connection to one terminal of the trip solenoid, a connection to VDC, a connection to DC sense, a voltage detection mechanism, and a transistor; (b) detecting a voltage anomaly using the voltage detection mechanism, the voltage anomaly resultant of an existing fault; (c) exceeding a voltage-blocking threshold of the voltage detection mechanism of step (b); (d) activating the transistor as a direct result of step (c); (e) drawing current through the trip solenoid from the transistor of step (d); and (f) breaking the circuit.

### BRIEF DESCRIPTION OF THE DRAWING FIGURES

FIG. 1 is a schematic diagram illustrating a protection circuit connected to a typical circuit breaker circuitry and voltage distribution wiring illustrating normal current flow conditions with the protection circuit in an off state according to an embodiment of the present invention.

FIG. 2 is a schematic diagram illustrating the protection circuit of FIG. 1 connected to the circuit breaker and voltage distribution wiring of FIG. 1, the protection circuit active under a Bolted Short condition.

FIG. 3 is a schematic diagram of the protection circuit of FIGS. 1 and 2 connected to the circuit breaker circuitry and voltage distribution wiring of

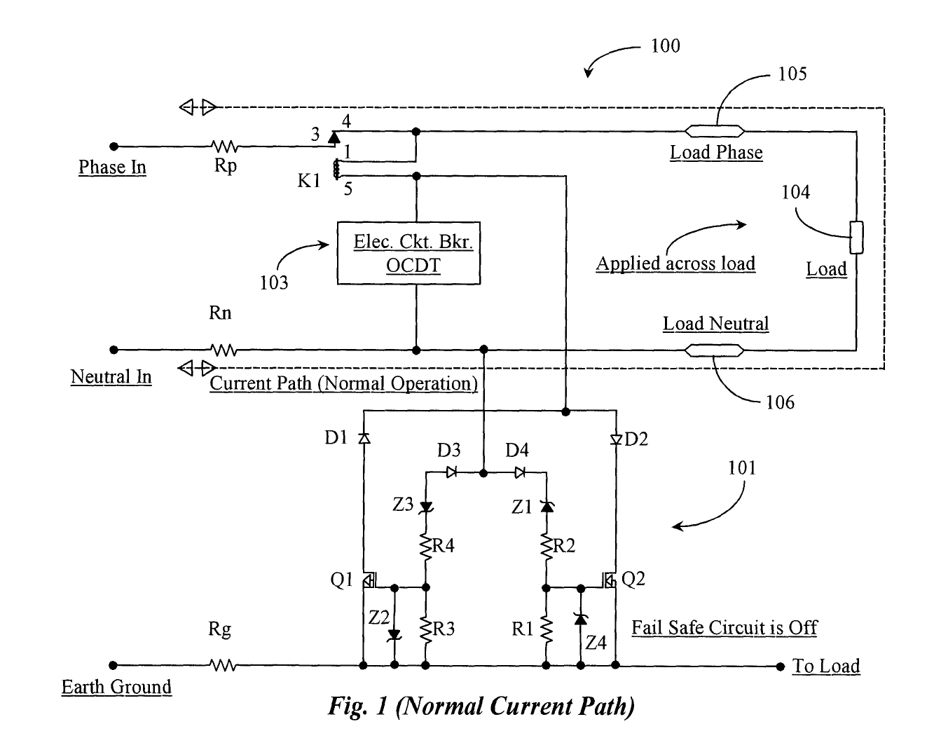

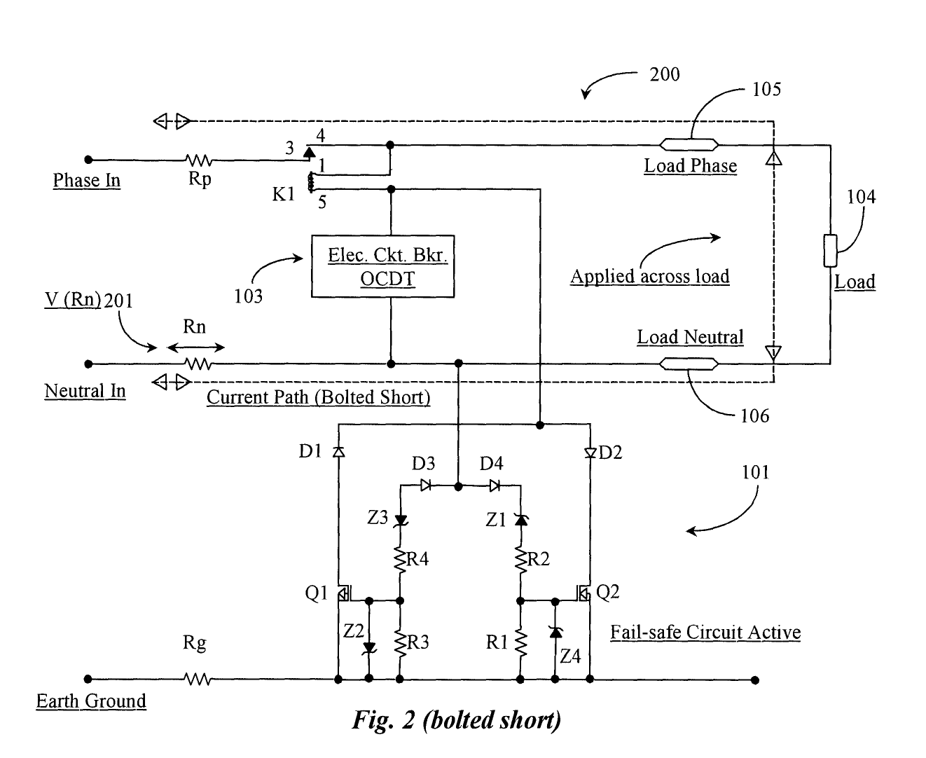

FIGS. 1 and 2 illustrating a preferred Solenoid activation current path according to an embodiment of the present invention.

FIG. 4 is a schematic diagram illustrating the protection circuit of FIGS. 1-3 connected to the circuit breaker circuitry and voltage distribution wiring of FIGS. 1-3 illustrating Solenoid activation by the protection circuit under an Open Neutral condition according to an embodiment of the present invention.

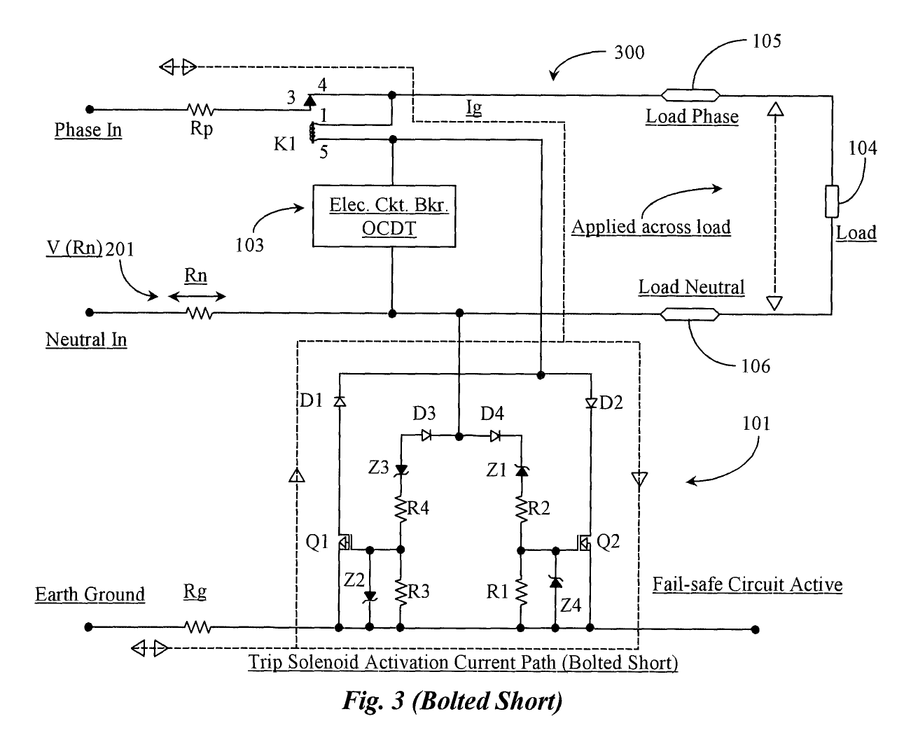

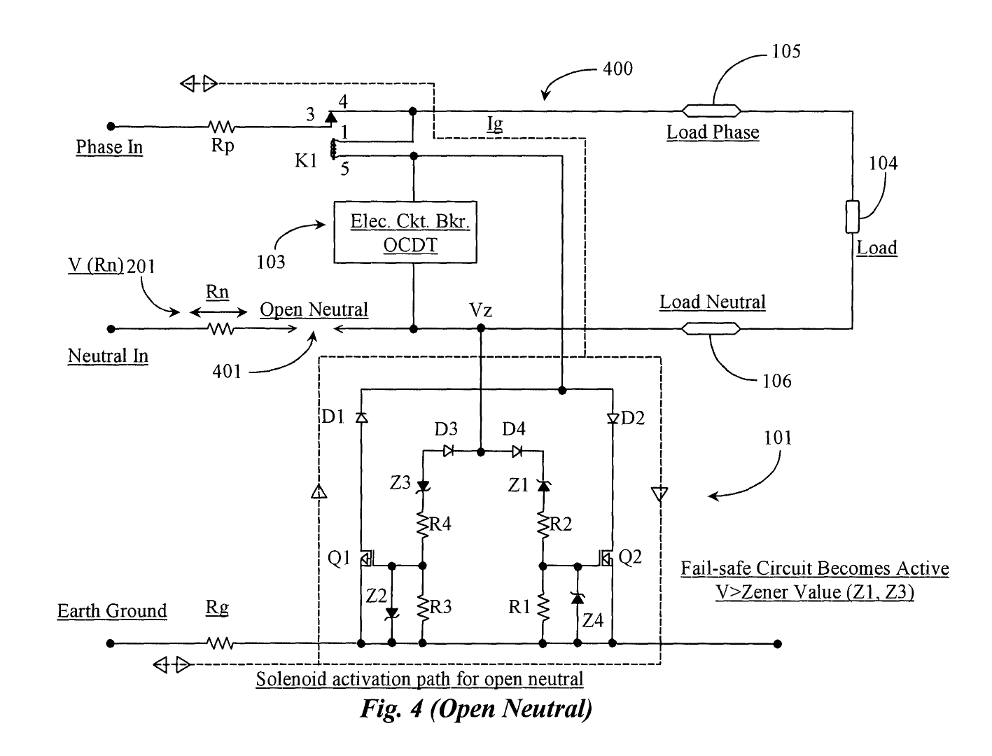

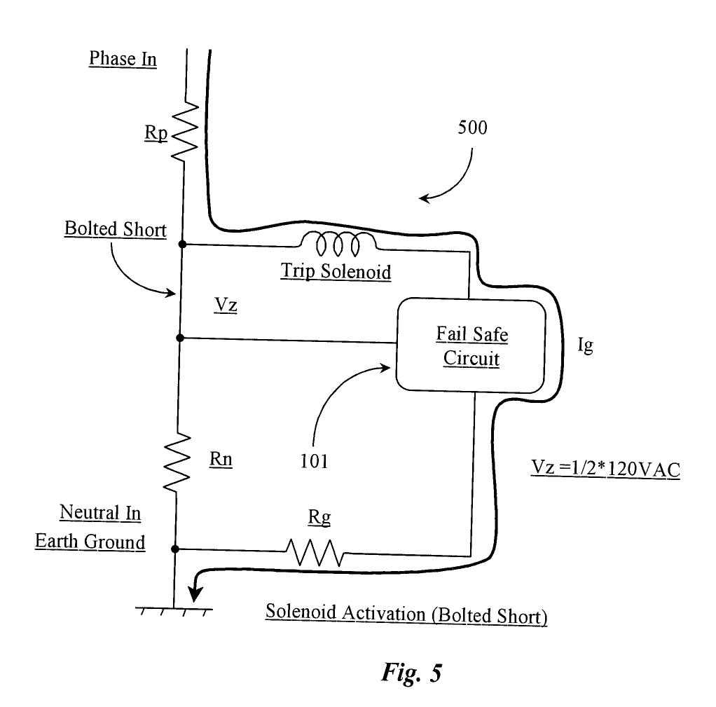

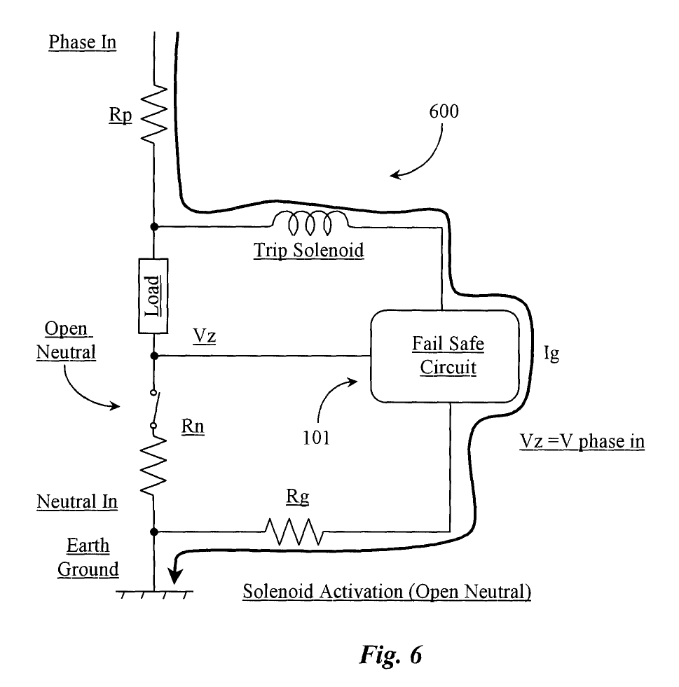

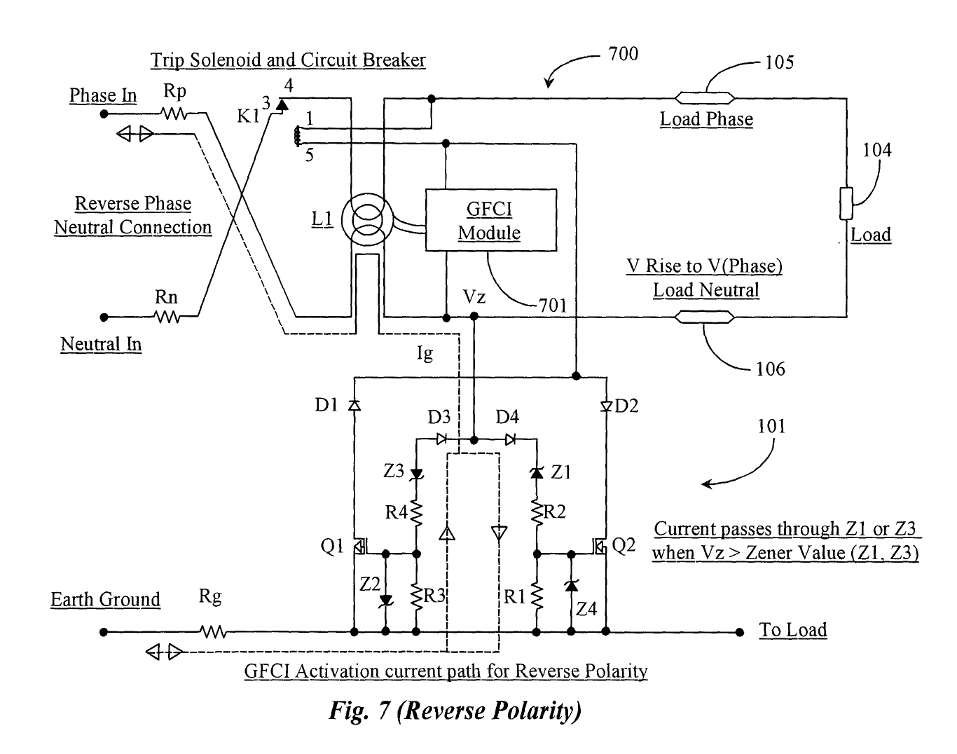

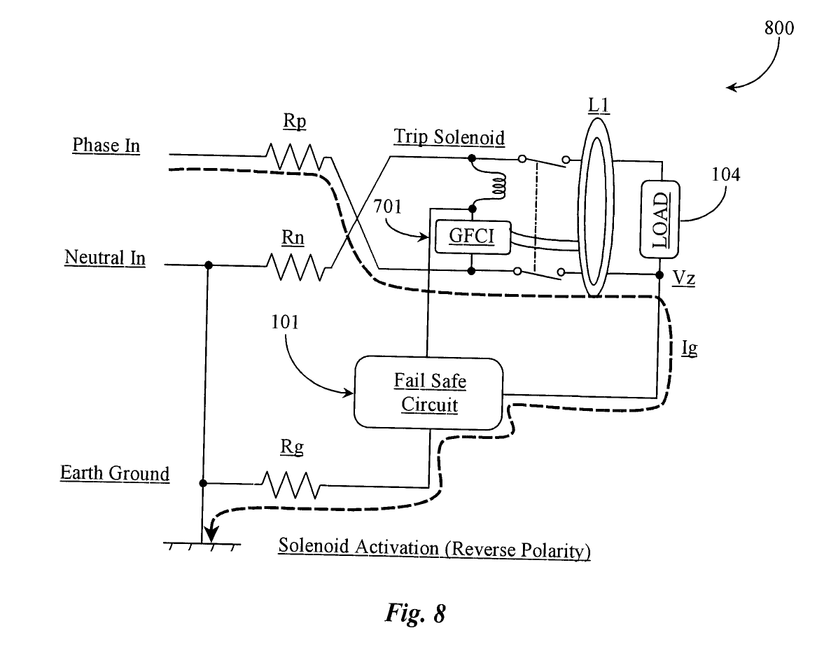

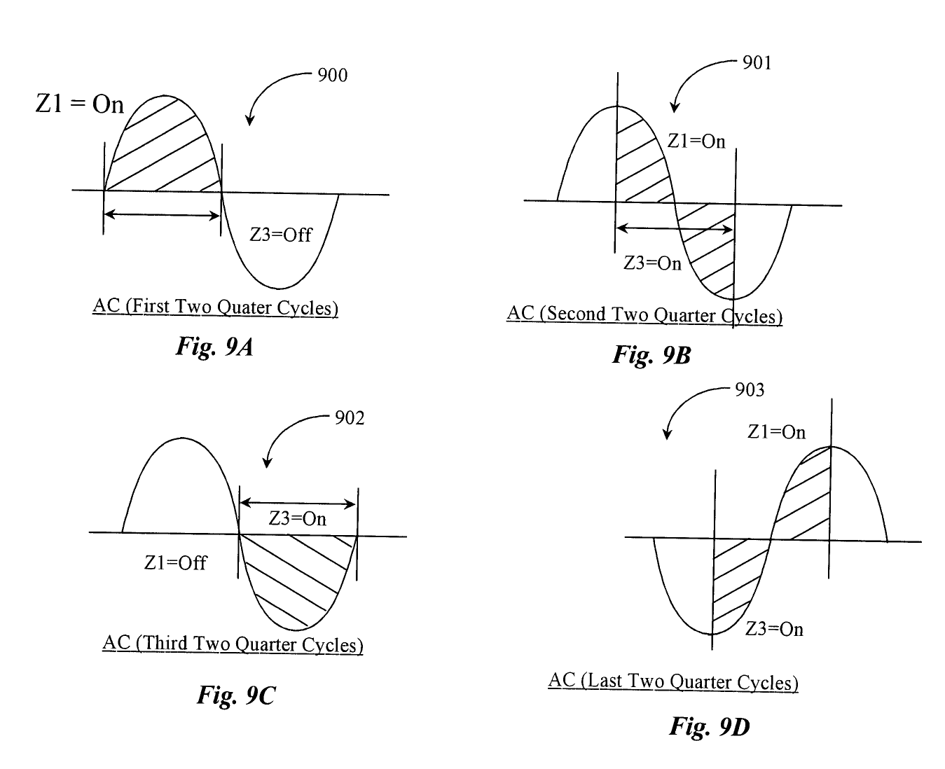

FIG. 5 is a simplified diagram of the circuitry of FIG. 3 conceptually illustrating the Bolted Short condition and Solenoid activation current path of FIG. 3.

FIG. 6 is a simplified diagram of the circuitry of FIG. 4 conceptually illustrating the Open Neutral condition and Solenoid activation path of the protection circuit of FIG. 4.

FIG. 7 is a schematic diagram illustrating AC circuitry and voltage distribution wiring and a GFCI activation path wherein a Reverse Polarity occurs due to miss wiring.

FIG. 8 is a much-simplified diagram illustrating the GFCI activation path of FIG. 7.

FIG. 9A is a waveform graph illustrating Zener Diode activation regions during the first two of four quarter cycles of an AC cycle.

FIG. 9B is a waveform graph illustrating Zener Diode activation regions during the second two of four quarter cycles of an AC cycle.

FIG. 9C is a waveform graph illustrating Zener Diode activation regions during the third two of four quarter cycles of an AC cycle.

FIG. 9D is a waveform graph illustrating Zener Diode activation regions during the last two of four quarter cycles.

### DESCRIPTION OF THE PREFERRED EMBODIMENTS

FIG. 1 is a schematic diagram 100 illustrating a protection circuit 101 connected to a typical electronic circuit breaker circuitry and voltage distribution wiring illustrating normal current flow conditions with circuit 101 in an off state according to an embodiment of the present invention. The circuit breaker circuitry and voltage distribution wiring of schematic 100 is assumed to be typical of wiring from a voltage distribution panel to an appliance load and includes a mechanical circuit breaker switch illustrated herein as circuit breaker switch K1. An electronic circuit breaker module, in this case, an Over Current Trip Detection (OCTD) module is illustrated herein as a logical block 103. Block 103 may represent a variety of known breaker types such as a Ground Fault Circuit Interrupter (GFCI), an Arc Fault Circuit Interrupter (AFCI), or an Over Current Trip Detector (OCTD), which is the type illustrated in this example as module 103.

The circuitry and voltage distribution wiring of schematic 100 includes a Phase In wire, a Neutral In wire, and an Earth Ground wire as is known in the art of current-to load distribution. The Earth Ground wire originates as an electrical safety ground at the service entrance of a power distribution system. Typically all three of these wires are wrapped in a single conduit and are of the same length leading to the load. As is known in the art, a power distribution point may be wired for 220VAC, 120VAC or other AC voltages. Each of the three mentioned wires has a parasitic resistance illustrated herein by a Resistor Rp for Phase, a Resistor Rn for Neutral, and a Resistor Rg for Ground. The resistance values of Rp, Rn, and Rg are equal due to a fact that all three wires are of the same length and gauge as previously stated.

Phase In current passes through resistor Rp, through a pin 3 and a pin 4 of a breaker switch of circuit breaker K1 and flows to an electrical Load, illustrated herein as a Load 104 through a Load Phase connector illustrated herein as a Load Phase 105. A Trip Solenoid Pin (1) is provided as a first terminal for Trip Solenoid activation and is connected on the Load or Phase In side of circuit breaker switch K1, which includes pins 3 and 4. A Trip Solenoid pin (5) is illustrated herein opposite pin (1) and is the second terminal of the Solenoid of breaker switch K1. Neutral In current passes through resistor Rn and through a Load Neutral connector, illustrated herein as Load Neutral 106, to electrical Load 104.

Protection circuit 101, termed a “Failsafe” circuit by the inventors is provided for the purpose of tripping mechanical circuit beaker K1 in the event of a Bolted Short, an Open Neutral condition. Protection circuit 101 is connected directly to a terminal (Pin 5) of circuit breaker K1. Protection circuit 101 also has a connection path from Neutral In to Earth Ground through optimal paths of the circuit itself.

Protection circuit 101 includes but is not limited to certain Diodes illustrated herein as Diodes D1, D2, D3, and D4. Diodes D1-D4 are strategically arrayed along optimal current paths through circuit 101. Protection circuit 101 also includes Zener Diodes Z1, Z2, Z3, and Z4. Zener Diodes Z1 -Z4 are also strategically arrayed along optimnal current paths through circuit 101. Protection circuit 101 also has metal-oxide semiconductor field-effect transistors (MOSFETS) illustrated herein as a MOSFET Q1 and a MOSFET Q2 along with illustrated resistors R1, R2, R3, and R4. MOSFETS Q1-Q2 and R1-R4 are strategically arrayed for function along optimal circuitry paths.

In this example, protection circuit 101 is in an off state. In this mode there are no conditions apparent with reference to the pre-existing breaker and voltage distribution wiring of schematic 100 that would necessitate tripping of the Solenoid (pins 1, 5). A normal current flow through the breaker and voltage distribution wiring is illustrated in this example by a dotted line labeled Current Path (Normal Operation).

During normal operation with no problems detected, voltage potential between Neutral and Earth Ground is close to OV because normal current flow, approximately 25 amps rms (square root of the mean squared), is not sufficient to generate a large enough voltage drop across resistor Rn of Neutral In. In this example for a 120V application, protection circuit 103 is maintained in an off state by way of current-blocking Zener Diodes Z3 and Z1 (rated at 30V each). No current is able to pass through the circuit to gate resistors R3 or R1 (rated at 25K each). This results in an off state for MOSFETS Q1 and Q2. Therefore, in a normal operating state, no current flows across pins 1 or 5 of breaker K1 and no current flows from Neutral to Ground. Protection circuit 101 remains in an off state until such time as a fault occurs.

Protection circuit 101 is unique in that it can operate in conjunction with a wide variety of existing circuit breaker modules without interruption of the normal functions of those modules and without drawing any current from those modules. It is noted herein that Resistors R4 and R2 are rated at 5K. Zener Diodes Z2 and Z4 are rated at 10V each.

FIG. 2 is a schematic diagram 200 illustrating protection circuit 101 of FIG. 1 connected to the circuit breaker and voltage distribution wiring of FIG. 1, circuit 101 active under a Bolted Short condition. Schematic 200 includes all of the components described with reference to FIG. 1 above. Therefore those components illustrated in this example that were introduced with reference to FIG. 1 shall not be re-introduced and shall retain their original element numbers.

Schematic 200 illustrates a Bolted Short condition occurring across the operational Load from Load Phase 105 to Load Neutral 106 as illustrated by a dotted current path labeled herein Current Path (Bolted Short). During this condition there exists a large voltage between Neutral In and Earth Ground due to a high amount of current, (limited only by the source impendence), flowing through Neutral In and resulting in a large voltage drop across resistor Rn. This large voltage potential is the result of current flowing through Neutral In from the bolted short applied across Load 104 back to the distribution panel. Because the amount of current generated during a Bolted Short is very high a large voltage results even though Rn is very small. The Bolted Short condition causes Resistor Rp and Resistor Rn to form a voltage divider network, the Bolted Short forming a junction there between.

Protection circuit 101 detects the rise in voltage potential between Neutral In and earth ground by way of the Zener Diode tree formed by Z3, R4 and gate Resistor R3 for the negative half cycle of the AC. For the positive half cycle of the AC, the Zener Diode tree formed by Z1, R2, and gate Resistor R1 detects the voltage drop. As the waveform for the negative AC half cycle exceeds the breakdown voltage rating of Zener Diode Z3, MOSFET Q1 (P (positive)-Channel enhancement-mode device) transitions to an active state. Likewise, as the waveform for the positive half cycle exceeds the rating of Zener Diode Z1, MOSFET Q2, (N (negative)-Channel enhancement-mode device) transitions to an active state. MOSFET activation with respect to Q1 or alternatively Q2, depending on which half cycle the Bolted Short occurred, enables sufficient current to flow through Trip Solenoid pins 1 and 5 of circuit breaker switch K1 and through protection circuit 101 to Earth Ground to break the circuit. The current flow causes activation of the Trip Solenoid and the mechanical circuit breaker switch to open thereby shutting off the Phase In current to Load 104 and clearing the Bolted Short condition. It is noted herein that protection circuit 101 utilizes the negative or positive half cycle MOSFETS Q1 or Q2 at their lowest resistance values. The response time for activation of the Trip Solenoid is between one to two consecutive quarters of an AC cycle. This means that at certain times both Zener Diodes Z1 and Z3 are alternately active in either positive or negative AC cycles. The four distinct activation regions for the protection circuit 101 will be illustrated later in this specification. The actual activation can start anywhere within these four regions.

In order to properly gauge and tune circuit 101 for proper operation during a Bolted Short condition, Zener diodes Z1 and Z3, which are current blocking Diodes, must be selected with a voltage maximum rating that is somewhat proportional to one half of the line voltage for the electric circuit.

In one embodiment of the present invention, circuit 101 is adapted as a programmable circuit. In this embodiment one or more additional sets of Zener Diodes and Resistors can be added in parallel to the circuit along with a programmable selector circuit that is adapted to allow a particular set of Diodes and Resistors to be utilized in a particular current path according to the operating value of the line voltage. In this embodiment protection circuit 101 can be implemented according to a variety of scenarios and is therefore interchangeable or modular with reference to a variety of line voltage values.

In another embodiment of the present invention, circuit 101 can be implemented as a programmable or non-programmable application specific integrated circuit (ASIC) without departing from the spirit and scope of the present invention.

FIG. 3 is a schematic diagram of protection circuit 101 of FIGS. 1 and 2 connected to the circuit breaker circuitry and voltage distribution wiring of FIGS. 1 and 2 illustrating a preferred Solenoid activation current path according to an embodiment of the present invention.

FIG. 5 is a simplified diagram of the circuitry of FIG. 3 conceptually illustrating the Bolted Short condition and Solenoid activation current path of diagram 300 of FIG. 3.

Referring now to FIG. 3, diagram 300 illustrates both the Bolted Short condition and the physical Solenoid activation current path from Solenoid, through circuit 101 to Earth Ground in a preferred embodiment.

All of the elements described herein are also present in both FIGS. 1 and 2 shall retain their same element numbers and shall not be re-introduced.

As was previously described above MOSFETS Q1 or Q2 once activated cause a current flow illustrated herein as Ig (current to Ground) resulting in activation of Trip Solenoid (pins 1 and 5) after Zener Diode detection of the Bolted Short condition. More particularly, the Zener values of Zener Diodes Z1 and Z3 set the trip activation threshold for MOSFET activation depending on which AC half cycle during which the Bolted Short occurs. In this embodiment for a line voltage of 120 VAC, the values of Zener Diodes Z1 and Z3 are approximately 30 V; the Zener value of Z1 and Z3 changes for different line voltage values. It is noted herein that the use of Zener diodes is preferred because of the more precise breakdown voltage measurements of such devices over other devices that might be used, some of which were described in the background section of this specification with reference to prior-art. It is also noted herein that a voltage regulation mechanism (not illustrated) may be provided within circuit 101 to enable regulation of the amount of current allowed to activate the Trip Solenoid.

As long as the Neutral-to-Ground voltage is below the Zener values of Z3 & Z1, protection circuit 101 is idle (in an off state) and does not draw any current. In this state no current can flow through MOSFETS Q1 or Q2 except for their respective device leakage currents. At the point the Neutral to Ground voltage rises above the Zener voltage values either for positive or for negative AC half cycles, current flows through either R4 & R3 (negative half-cycle) or R2 & R1 (positive half-cycle) to raise the gate-source voltage for Q1 or Q2 respectively. As the Neutral to Ground voltage continues to rise, the gate-source voltage will increase until it is limited by Zener diodes Z2 for R4 and R3, and Z4 for R2 and R1. Diodes Z2 and Z4 are strategically placed to prevent gate breakdown of MOSFETS Q1 & Q2 respectively.

In this embodiment, Diode D3 permits only negative AC half cycle activation of MOSFET Q1, while Diode D4 permits only positive AC half cycle activation of MOSFET Q2. Additionally, Diode DI is provided to prevent the positive AC half cycle from conducting current through MOSFET Q1 while Diode D2 is provided to prevent the negative AC half cycle from conducting current through MOSFET Q2. In this example, the Trip Solenoid Activation Current Path Ig (so labeled) is illustrated herein by a dotted line. It is noted herein the path Ig will encompass Diode D1 or D2 depending upon which AC half cycle during which Bolted Short has occurred. In a preferred embodiment, the Trip Solenoid activation response time from the time of Zener detection is less than one AC half cycle.

Referring now to FIG. 5, a simplified circuitry diagram 500 is conceptually analogous to the more detailed wiring and circuitry illustrated with reference to FIG. 3. The inventor provides this more simplified example to provide further clarity of Solenoid activation during a Bolted Short. Phase In is, in this example wired for 120 VAC. Conceptually, the Bolted Short occurs between Resistor Rp (Phase line) and Resistor Rn (Neutral line). Therefore Rp and Rn act as a voltage divider network as previously described. Therefore Vz represents the voltage across Rn. Vz=1/2(120 VAC) since Rp=Rn. Protection circuit 101 is logically illustrated with connections to the Solenoid, Neutral, and Ground. The current path activated through the Trip Solenoid, through the “Fail Safe Circuit” to Ground is labeled herein Ig and is analogous to path Ig described with reference to FIG. 3. Because of an independent connection between the circuit of the present invention and the Trip Solenoid, the protection circuit (101) is always off until a Bolted Short occurs and then returns to an off state after the breaker has opened and effectively removing the Bolted Short condition.

FIG. 4 is a schematic diagram illustrating protection circuit 101 of FIG. 1 connected to the circuit breaker circuitry and voltage distribution wiring of FIGS. 1-3 illustrating Solenoid activation by the protection circuit under an Open Neutral condition 401 according to an embodiment of the present invention.

FIG. 6 is a simplified diagram of the circuitry of FIG. 4 conceptually illustrating the Open Neutral condition and Solenoid activation path of circuit 101 of FIG. 4.

Referring now to FIG. 4, all of the components illustrated in circuitry and voltage distribution wiring 400 are also present in FIGS. 1-3 and therefore shall retain their original element numbers and shall not be reintroduced. In this example, Open Neutral condition 401 occurs, which as described in the background section, involves a break in Neutral In between Load Neutral 106 and the distribution panel. In this example the load may be as shown (load 104) or the load could be the OCDT circuit (103) itself.

Under the Open Neutral condition, Neutral In becomes disconnected (break 401) causing the voltage at Load Neutral connector (106) to rise dramatically to the voltage value of Phase In. Resulting voltage rise across Z3 or Z1 (depending on the AC half cycle) as described above, will act to turn on the associated Zener Diode (Z3 or Z1) and create a current flow through either the R4, R3 Resistor pair, or the R2, R1 Resistor pair that activates either MOSFET Q1 or MOSFET Q2 to draw current through D1 or D2, through K1 and through circuit 101 to Earth Ground thus tripping the Solenoid to open the circuit breaker shutting off the Phase voltage to Load. As was described with reference to FIG. 3 with reference to the Bolted Short condition, the voltage through Z3 or Z1 under an Open Neutral condition must be greater than the Zener values of the same in order to activate the MOSFETS. It is noted herein that under Open Neutral, the Trip Solenoid activation path (Ig) is identical to that for a Bolted Short condition described with reference to FIGS. 3 and 5. It is also noted herein that the activation paths for both a Bolted Short and Open Neutral are identical and separate from the detections paths, which are also identical. This is because MOSFET activation is used in both cases to open the circuit breaker. Under a reverse Polarity condition, the MOSFETS are not used for solenoid activation. Only the voltage detection paths (Zener/Resistor) are used in conjunction with a GFCI as will be discussed further below.

FIG. 6 is a much-simplified diagram 600 illustrating the Trip Solenoid activation path of the circuitry and wiring of FIG. 4. The inventor provides this much-simplified diagram for the purpose of clarity in illustration. Diagram 600 illustrates protection circuit 101, represented logically herein as a block 101. Visible are the connections from circuit 101 to the Solenoid, to Neutral, and to Ground.

In this example an Open Neutral condition is illustrated as occurring between Resistor Rn and Load 104. The condition is represented herein by a break in or disconnection of the line labeled herein Open Neutral. In order for protection circuit 101 to detect this condition, a Load must be connected in between Phase Resistor (Rp) and Neutral Resistor (Rn), this could simply be the relay K1 and OCDT 103 in FIG. 4. The Trip Solenoid activation path (Ig) is identical to that illustrated with reference to FIG. 5 above.

It is noted herein and will be apparent to one with skill in the art that protection circuit 101 accomplishes the task of independent Solenoid activation by monitoring the voltage between Neutral and Earth Ground. During a Bolted Short a large amount of current will flow from Phase to Neutral. The current flowing through the Neutral wire will generate a voltage drop from the point of the short to the distribution Panel where Neutral and Ground are connected. The voltage difference between Neutral and Ground during an Open Neutral is caused by the break or disconnect (401) of the Neutral line from the Load.

In the case of a Bolted Short, it is the voltage drop that raises the voltage difference between the Neutral and Ground wires. Typically this voltage drop will be one half of the normal voltage at the Phase line. The circuit of the present invention first detects that the Neutral to Ground voltage exceeds it normal value then turns on certain MOSFET transistors to enable current to flow through the Trip Solenoid and onto the Ground wire causing the mechanical circuit breaker to open. In the case of Open Neutral as shown in FIGS. 4 and 6, the voltage across protection circuit 101 is illustrated herein as Vz=the voltage of Phase In (120 VAC) in this case, different from the Bolted Short scenario.

FIG. 7 is a schematic diagram 700 illustrating AC circuitry and voltage distribution wiring and a GFCI activation path wherein a Reverse Polarity occurs due to miss wiring of the Phase In and Neutral In.

FIG. 8 is a much-simplified diagram 800 illustrating the GFCI activation path of FIG. 7.

Referring now to FIG. 7, some of the elements described herein are also present in FIGS. 1-4. Therefore, those same elements shall retain their original element numbers and shall not be reintroduced.

In this example, breaker circuitry and voltage distribution wiring 700 shows the Phase In wire now connected to Load Neutral 106 and the Neutral In wire now connected to Load Phase 105. This condition is a Reverse Phase-Neutral condition or “Reverse Polarity” as often termed in the art.

Unlike the previous examples wherein an OCTD module is used, in this example a GFCI module 701 is provided for circuit interruption. This is because during a Reverse Polarity condition, the circuit (101) of the present invention uses a typical GFCI to activate the mechanical breaker switch K1. It is noted herein that there are no changes or modifications to circuit 101 to enable implementation with GFCI 701 to protect against a Reverse Polarity condition. GFCI 701 has a current sensing coil illustrated herein as L1. Coil L1 is adapted to monitor and then sense any current imbalance between Phase and Neutral. During a Reverse Polarity condition the voltage at Load Neutral 106 will be equal to Phase In voltage, which will cause circuit 101 to turn on. Some current Ig flows through the detection paths within failsafe circuit 101 to ground. The amount of current flow is typically 6 mA to about a 25 mA peak, sufficient to trip a GFCI detection circuit. It is noted herein that although Q1 and Q2 will turn on during this time, no current will flow through K1 because Neutral In and Earth Ground are at the same potential.

As shown in FIG. 7 a Reverse Polarity connection causes current Ig to flow through the D3, Z3, R4, R3 path or the D4, Z1, R2, R1 path to Earth Ground. This current flow Ig (about 25 mA peak) occurs automatically in the event of Reverse Polarity when power is supplied and results in an imbalance of the current flowing through the Phase and Neutral wires as shown in FIG. 7. It is noted herein that the current path Ig of this example is different than Ig described with reference to Bolted Short, or Open Neutral. This is because the protection circuit, in this case, uses GFCI 701 instead of MOSFET activation to activate the Trip Solenoid. It is also noted herein that current path Ig results directly from the miss wiring and not from Zener detection.

Referring now to FIG. 8, GFCI module 701 uses sensing coil L1 to detect the imbalance of current between Neutral and Phase and activates the trip solenoid to cause the mechanical circuit breaker to open. In this case power is shut off after power is supplied to the miss-wired distribution path (limited only by the response of the GFCI module).

One with skill in the art will recognize that the circuit of the present invention coupled to a typical GFCI device will protect against all three fault conditions mentioned in this specification without requiring any other electrical connection or mechanical modifications.

Referring now back to FIG. 1, the protection circuit of the present invention is further adapted to maximize current through the Trip Solenoid during a Bolted Short or Open Neutral to insure rapid tripping. Firstly, there are only two components in each path (depending on which AC half cycle) from K1 to Earth Ground. These are Diode D1 and MOSFET Q1 for the negative AC half cycle, and Diode D2 and MOSFET Q2 for the positive AC half cycle. Because Diodes D1 and D2 are forward biased, there is less than 1V drop in voltage across them. Further, the arrangement between the Zener Diodes and the MOSFETS cause the MOSFETS to enter saturation whenever protection circuit 101 is activated. In other words, in the “on” state, voltage resistance for MOSFETs Q1 and Q2 are at their lowest values. The Zener values for Zener diodes Z3 and Z4 are selected so that they will not conduct any current until a sufficiently high voltage is present between Neutral and Earth Ground. This insures that a high enough “gate-to-source” voltage exists for MOSFETs Q1 and Q2. Another contributing factor in maximizing the gate-to-source voltage is selection of Zener values for Z2 and Z4 such that they saturate their respective MOSFETs when activated.

The Underwriters Laboratory (UL), NEC, and other such safety agencies consider the Bolted Short and Open Neutral conditions potentially catastrophic. For this reason, NEC Section 250-6(c) allows for an existence of short duration current flow through Earth Ground in rectification of such conditions. The protection circuit of the present invention automatically shuts off after such conditions are rectified thereby ceasing any current to Ground.

As was described further above with reference to the description of FIG. 2, Solenoid activation can occur within one or two consecutive quarter cycles of a complete AC cycle. A complete AC cycle has two positive quarter cycles and two negative quarter cycles. Activation regions or quarter cycles within which activation may occur are described in detail below. Because this invention can trip a solenoid within one or two AC quarter cycles, it is best to describe the activation as pairs of quarter cycles.

FIG. 9A is a waveform graph 900 illustrating Zener Diode activation regions during the first pair of four quarter cycles of an AC cycle.

FIG. 9B is a waveform graph 901 illustrating Zener Diode activation regions during the second pair of four quarter cycles of an AC cycle.

FIG. 9C is a waveform graph 902 illustrating Zener Diode activation regions during the third pair of four quarter cycles of an AC cycle.

FIG. 9D is a waveform graph 903 illustrating Zener Diode activation regions during the last pair of four quarter cycles.

Referring now to FIG. 9A, waveform graph 900 illustrates a typical sine waveform associated with a portion of an AC cycle, showing the first two consecutive quarter cycles of a typical AC cycle. In this example, Zener Diode (Z1, positive) is on and Zener Diode (Z3, negative) is off.

Referring now to FIG. 9B, waveform graph 901 illustrates the second two consecutive quarter cycles. In this example both Z1 and Z3 are active in a shared region measured from the peak of the second quarter cycle to the peak of the third quarter cycle. Therefore, in this case MOSFET Q1 and Q2 alternately generate current Ig.

Referring now to FIG. 9C, waveform graph 902 illustrates the third pair of consecutive quarter cycles. This example reflects an opposite state from the example of FIG. 9A in that Z1 is now off and Z3 is now on.

Referring now to FIG. 9D, waveform graph 903 illustrates the last pair of consecutive quarter cycles of a complete AC cycle. Functionally speaking, this case is similar to the case of FIG. 9B wherein both Zener Diodes are alternately on and activating their respective MOSFETs.

One with skill in the art will concur from the examples of FIGS. 9A through 9D that during a Bolted Short or Open Neutral wherein MOSFETs are for Solenoid activation that there is not a region in a complete AC cycle wherein both Z1 and Z3 are off. The failsafe circuit of the present invention is off only when no current anomaly is detected. In this case no current flows to Earth Ground.

It will be apparent to one with skill in the art that the protection circuit of this invention operates according to detected Voltage levels. Therefore, in another embodiment of the present invention, a version of circuit 101 may be applied to Direct Current (DC) scenarios. For example, in a DC protection circuit only D2 and D4, MOSFET Q2, Resistors R1 and R2, and Zener Diodes Z1 and Z4 are necessary. In this embodiment, AC Phase in is replaced by VDC+. AC Neutral In is replaced by VDC−. AC Earth Ground is replaced by DC sense wire and is connected at the source of VDC−. Similar to current states for AC, the current flow in DC will take place through Load using VDC+ and VDC−. That is to say that no current will flow through a DC sense wire until a fault condition occurs. As long as the lengths of the VDC+ and VDC− wires are kept approximately the same and the Zener value of the blocking Zener Diode Z1 is changed according to VDC+ voltage and Resistance level of the DC scenario (typically in proportion with one half of the voltage value of VDC+), the DC version of protection circuit 101 will operate successfully.

In still another embodiment of the present invention, protection circuit 101 in either AC form or DC form may be implemented as a programmable ASIC without departing from the spirit and scope of the present invention.

The circuit of the present invention can be applied to work in conjunction with typical circuit breaker types and can be installed easily along side such breakers implementing the appropriate connections to Solenoid, Neutral In, and Earth Ground. In the DC embodiment, the connections are Solenoid, VDC, and DC Sense.

The methods and apparatus of the present invention should be afforded the broadest possible scope under examination in view of the various possible embodiments. The spirit and scope of the present invention is limited only by the following claims.

1. A protection circuit for generating sufficient current to activate a Trip Solenoid of a circuit breaker installed in an AC voltage distribution Load path in response to a detected fault condition comprising:
an electrical connection from the circuit to a terminal of the Trip Solenoid;
an electrical connection from the circuit to a Neutral wire of the Load path;
an electrical connection from the circuit to a Ground wire of the Load path;
at least one voltage detection mechanism for detecting a fault condition; and
at least one Transistor electrically accessible from at least one voltage detection mechanism for generating sufficient current to activate the Trip Solenoid;
characterized in that one of at least one voltage detection mechanism detects a voltage anomaly between the Neutral wire and the Ground wire resultant of a fault occurrence and activates one of at least one Transistor to generate a source-to-ground current independently from the circuit breaker, the generated current traveling through the Trip Solenoid and the protection circuit to Ground, the generated current sufficient to activate the Trip Solenoid thereby opening the circuit breaker.

2. The circuit of claim 1 wherein the circuit breaker is one of a Ground Fault Circuit Interrupter, an Arc Fault Circuit Interrupter, or an Over Current Trip Detector.

3. The circuit of claim 1 wherein the fault condition is one of a Bolted Short or an Open Neutral condition.

4. The circuit of claim 1 wherein the voltage anomaly detected is a voltage drop across inherent neutral wire impedance resulting from a Bolted Short condition.

5. The circuit of claim 1 wherein the voltage anomaly detected is a voltage rise across a Load Neutral connector resulting from an Open Neutral condition.

6. The circuit of claim 1 including two voltage detection mechanisms for detecting the voltage anomaly, one operative during the negative Alternating Current half cycle, and one operative during the positive Alternating Current half cycle.

7. The circuit of claim 6 wherein the voltage detection mechanisms each include a Zener diode and one or more resistors.

8. The circuit of claim 1 wherein at least one transistor is a metal-oxide semiconductor field-effect transistor (MOSFET).

9. The circuit of claim 8 including two MOSFETs, one operative during the negative alternating current half cycle and one operative during the positive alternating current half cycle.

10. The circuit of claim 1 having an off state during no-fault operation and an on state upon detection of a fault, the circuit returning again to the off state after tripping the circuit breaker and the fault condition is removed.

11. The circuit of claim 1 having a detection-to-activation response time of less than one AC half cycle.

12. The circuit of claim 1 wherein the level of trip solenoid activation current is adjustable using a voltage adjustment mechanism.

13. In an AC voltage distribution environment, a method for detecting a fault condition and for generating a current to activate a trip solenoid of a circuit breaker protecting a load, comprising steps of:
(a) providing a protection circuit between the power distribution source and Ground, the protection circuit having a connection to one terminal of the trip solenoid, a connection to neutral, a connection to ground, at least one voltage detection mechanism, and at least one voltage transistor;
(b) detecting a voltage anomaly using one of at least one voltage detection mechanism, the voltage anomaly resultant of an existing fault;
(c) exceeding a voltage-blocking threshold of the voltage detection mechanism of step (b);
(d) activating one of at least one semiconductor switch (such as a transistor) as a direct result of step (c);
(e) drawing current through the trip solenoid from the transistor of step (d); and
(f) breaking the circuit.

14. The method of claim 13 wherein in step (b) the voltage detection mechanism includes a Zener diode, at least one resistor, and the semiconductor switch is a MOSFET.

15. The method of claim 13 wherein the electronic circuit breaker is one of a GFCI, an AFCI, or an OCTD circuit.

16. The method of claim 13 wherein in step (b) the voltage anomaly is one of a voltage drop across a neutral wire impedance or a rise in voltage at neutral load connector.

17. The method of claim 13 wherein in step (b) the existing fault is one of a bolted short or an open neutral condition.

18. The method of claim 13 wherein in step (c) the voltage threshold is that of a Zener diode.

19. The method of claim 13 wherein in step (d) the semiconductor switch is a MOSFET.

20. The method of claim 13 wherein in step (e) the current path includes the protection circuit and earth ground, bypassing the circuit breaker module.

21. A protection circuit for causing a GFCI to activate an associated trip solenoid upon detection of a reverse neutral and phase connection in an AC voltage distribution-to-load path comprising:
an electrical connection from the circuit to a neutral wire of the AC current load path;
an electrical connection from the circuit to an earth ground wire of the AC current load path; and
at least one voltage detection mechanism for detecting the reverse neutral and phase connection;
characterized in that upon supplying power to the AC voltage distribution-to load path, current flows through the at least one voltage detection mechanism to ground thereby causing a current anomaly between phase and neutral, the anomaly sensed by a sensing coil of the GFCI, which then generates the current to activate the trip solenoid shutting off phase power to load.

22. A protection circuit for generating sufficient current for activating a trip solenoid of a circuit breaker installed in a DC voltage distribution load path in response to a detected fault comprising;
an electrical connection to VDC−;
an electrical connection to DC sense wire;
a voltage detection mechanism for detecting a voltage anomaly; and
a transistor for generating a current through the solenoid and through the protection circuit to the DC sensing wire;
characterized in that the voltage detection mechanism detects a voltage anomaly between the VDC− wire and the DC sense wire resultant of a fault occurrence and activates the transistor to generate a source-to-ground current independently from the circuit breaker, the generated current traveling through the trip solenoid and the protection circuit to DC Sense, the generated current sufficient to activate the trip solenoid thereby opening the circuit breaker.

23. The protection circuit of claim 22 wherein the fault is one of a bolted short or an open VDC−condition.

24. In a DC voltage distribution environment, a method for detecting a fault condition and for generating a current to activate a trip solenoid of a circuit breaker protecting a Load comprising steps of:
(a) providing a protection circuit between the power distribution source and DC sense, the protection circuit having a connection to one terminal of the trip solenoid, a connection to VDC, a connection to DC sense, a voltage detection mechanism, and a transistor;
(b) detecting a voltage anomaly using the voltage detection mechanism, the voltage anomaly resultant of an existing fault;
(c) exceeding a voltage-blocking threshold of the voltage detection mechanism of step (b);
(d) activating the transistor as a direct result of step (c);
(e) drawing current through the trip solenoid from the transistor of step (d); and
(f) breaking the circuit.
